(19) United States
(12) Patent Application Publication
(10) Pub. No.: US 2026/0262559 A1
(43) Pub. Date: Sep. 10, 2026

(54) Agricultural Singulation Device for Singulating Particulate Material

(71) Applicant: Amazonen-Werke H. Dreyer SE & Co. KG, Hasbergen (DE)

(72) Inventors: Thomas WIEN, Stuhr (DE); Luca DULLWEBER, Bakum (DE)

(73) Assignee: Amazonen-Werke H. Dreyer SE & Co. KG, Hasbergen (DE)

(21) Appl. No.: 19/167,043

(22) PCT Filed: Mar. 12, 2024
(86) PCT No.: PCT/EP2024/056470

§ 371 Date: Sep. 19, 2025

(30) Foreign Application Priority Data
Mar. 21, 2023 (DE) 10 2023 107 040.1
Mar. 23, 2023 (DE) 10 2023 107 369.9

(51) Int. Cl. A01C 7/04

(52) U.S. Cl. CPC A01C 7/0445; A01C 7/046

(57) ABSTRACT

An agricultural singulation device for singulating particulate material comprising a housing with a shaft rotatably mounted in an interior of the housing and defining a rotation axis, and a singulation element which is received in an interior defined in the housing. The singulation element is coupled to the shaft such that the singulation element is mounted rotatably relative to the housing. The singulation element is arranged in the housing such that a first region and a second region are defined in the housing, wherein a pressure differential may be generated between these regions to cause particles of the particulate material to adhere at the singulation element in the first region.

### CROSS REFERENCE TO RELATED APPLICATIONS

The present application claims priority under 35 U.S.C. § 365 to PCT/EP2024/056470 filed on Mar. 12, 2024 and under 35 U.S.C. § 119(a) to German Application No. 10 2023 107 040.1 filed on Mar. 21, 2023 and German Application No. 10 2023 107 369.9 filed on Mar. 23, 2023, all of which are incorporated by reference in their entireties.

### TECHNICAL FIELD

The disclosure relates to an agricultural singulation device for singulating particulate material.

### BACKGROUND

For a farmer, optimizing yield and costs in farm operations is of importance. It requires applying seed with the greatest possible accuracy in terms of the amount dispensed and the spatial distribution of the seed on agricultural land. For this purpose, a variety of agricultural implements have been used, for example towed and/or mounted implements. Such implements can include, inter alia, agricultural seeders which serve to deliver particulate material, in particular seed and/or fertilizer, onto an agricultural field. To this end, such seeders comprise, in addition to at least one reservoir suitable for holding the particulate material, at least one, in particular pneumatic, conveying device for supplying the particulate material to at least one singulation device arranged on the seeder. In other embodiments, the particulate material may alternatively or additionally be supplied to the singulation device from the reservoir by gravity. The singulation device is configured to at least partially singulate the supplied particulate material and, depending on the type of particulate material, in particular seed and/or fertilizer, to discharge it toward the agricultural field in a demand-appropriate manner.

Depending on the type or variety, the particulate material is to be applied along the field at different seeding rates and/or spacings from one another. To meet this need with devices of the generic type, various approaches have been used, e.g., familiar single-seed (precision) planters as described in each of DE 10 2007 062 968 A1, EP 0 329 095 A1, EP 2 375 880 A1, and EP 3 735 814 A1.

Typically, a single-seed planter comprises a singulation device for singulating seed that is arranged in a housing. The singulation device comprises a singulation element made of plastic that is rotatably driven by a shaft, and a rotary plate which is in sliding mechanical contact with the singulation element, the rotary plate and the singulation disk not being rigidly connected to one another. When the singulation disk rotates, the rotary plate is also set into rotation and carried along by the mechanical contact with the singulation disk, so that, in this sense, the mechanical contact between the singulation disk and the rotary plate provides a “sliding seal.”

In an example singulation device, the interior of the housing is divided by the singulation element into two regions such that a pressure differential may be generated in the housing between a first region and a second region by means of a blower. Typically, the singulation element has, along its circumferential direction and/or in its outer region near the circumferential line, through-openings at regular intervals suitable for taking along individual kernels of the particulate good. The through-openings provide spatial connections between the first and second regions of the housing. Due to the pressure differential, the kernels adhere at these through-openings. In addition, at a suitable location the singulation device has a cover element which, by temporarily covering the through-openings, interrupts the pressure differential and thus prevents the continued adhesion of the kernels being carried at the through-openings.

### SUMMARY

There is an ongoing need to optimize accuracy in the placement of seed and/or fertilizer by seeders without complex construction and with low wear, while providing high service life and maintenance-free operation of seeders at a good cost-benefit ratio.

This object can be achieved by at least on embodiment of an agricultural singulation device for singulating particulate material described herein. Further advantageous embodiments of the disclosure are described herein.

According to a first aspect of the disclosure, an agricultural singulation device for singulating particulate material, in particular seed and/or fertilizer, is provided. In illustrative embodiments, in this aspect the singulation device comprises a housing with a shaft rotatably mounted in the interior of the housing, which defines a rotation axis, a bell element, and a singulation element which is received in the housing and coupled to the shaft in the interior such that the singulation element is mounted rotatably relative to the housing, and which has a plurality of through-openings extending through the singulation element. The singulation element is arranged in the housing such that the interior of the housing is divided into a first housing region as an overpressure region during operation of the singulation element and a second housing region as an underpressure region during operation of the singulation element. A pressure differential may be generated between the first region and the second region in order to cause particulate material to adhere to the singulation element in the first region relative to the second region. The singulation device further has a labyrinth seal in the second region, which is formed by a first sealing section at a circumference of the singulation element and a second sealing section at one or more inner walls of the housing, such that the first sealing section and the second sealing section are intermeshing structures without mechanical contact.

In a second aspect of the disclosure, an agricultural singulation device for singulating particulate material, in particular seed and/or fertilizer, is provided, the singulation device comprising a housing with a housing assembly and a cover assembly releasably mounted on the housing assembly, and a singulation element received in an interior defined in the housing. Here, the housing assembly or the cover assembly has a rotatably mounted shaft (which defines a rotation axis), and the singulation element is coupled to the shaft such that the singulation element is mounted rotatably relative to the housing. Furthermore, the singulation element is arranged in the housing such that a first region is defined between the singulation element and the housing assembly. In addition, the singulation element is arranged in the housing such that a second region is defined between the singulation element and the cover assembly, a pressure differential being generatable between these regions to cause adhesion of particulate material to the singulation element. The singulation device further has a labyrinth seal which is formed by a first sealing section at a circumference of the singulation element and a second sealing section at the cover assembly, such that the first and second sealing sections are intermeshing structures without mechanical contact.

A singulation device according to the first and second aspects of the disclosure exhibits a simplified construction because elements such as a rotary plate may be omitted, and it has advantageous service life and maintenance-free operation by dispensing with sliding components and, in particular, sliding seals. Thus, such a singulation device is cost-efficient.

In illustrative embodiments of the various aspects of the disclosure, an agricultural singulation device for singulating particulate material, in particular seed and/or fertilizer, is provided. As described above, the singulation device may comprise a housing with a housing assembly that has a rotatably mounted shaft which defines a rotation axis, and a cover assembly releasably mounted on the housing assembly. The singulation device furthermore comprises a singulation element which is received in an interior defined in the housing. The singulation element is coupled to the shaft such that the singulation element is mounted rotatably relative to the housing. Thus, the shaft and the singulation element rotate, while the housing with its components is stationary.

Furthermore, in the second aspect, as described above, the singulation element may be arranged in the housing such that a first region is defined between the singulation element and the housing assembly, and a second region is defined between the singulation element and the cover assembly. For example, the cover assembly may comprise a housing cover which, together with the housing assembly, defines the interior of the housing, the second region being defined between the housing cover and the singulation element.

In the various aspects of the disclosure, as described above, a pressure differential may be generated in the interior of the housing between the first and second regions by means of a pressure reservoir. A pressure reservoir may provide overpressure or underpressure. For example, a pressure reservoir may be implemented by a blower or a vacuum source, by a vessel containing a pressurized fluid, by a pump, etc. Advantageously, on a seed side of the singulation element (i.e., the side of the singulation element to which seed is supplied during operation) a higher pressure is applied than on the side of the singulation element opposite the seed side, so that kernels of seed are moved to bores of the singulation element and adhere there due to the pressure differential.

In the various aspects of the disclosure, the singulation element has a radial row of through-openings—for example, through-openings arranged at regular intervals in the radial row—for taking along individual kernels of the particulate material. The through-openings provide spatial connections between the first and second regions of the housing, and, due to the pressure differential, the kernels adhere at these through-openings.

This makes it possible, advantageously, to optimize singulation quality by adjusting the pressure differential for different geometries of the seed to be applied; singulation of kernels by pressure differential in operation may be more reliable and less sensitive for different kernel geometries than mechanical singulation by volume such as by spoons and/or pockets.

A “radial row” denotes a row of through-openings at a constant radius from a center point of the singulation element, for example a point of penetration where the rotation axis defined by the shaft passes through the singulation element. Additional radial rows with different radii and, optionally, different through-opening sizes and/or spacings may be provided. As a result, the singulation element may be used for applying an increased quantity of seed or seed of different kernel sizes. A pressure guidance may also be set via the through-openings.

In illustrative examples herein, the singulation element may have, along its circumferential direction, i.e., in the azimuthal direction, and/or in its outer region near the circumferential line, through-openings at regular intervals. The through-openings may provide spatial connections between the first and second regions of the housing, and the kernels may adhere at these through-openings due to the pressure differential.

Furthermore, in the various aspects of the disclosure, as described above, the singulation device also has a labyrinth seal which is formed by a first sealing section at a circumference of the singulation element and a second sealing section at one or more inner walls of the housing, for example at the cover assembly in the interior of the housing, such that the first sealing section and the second sealing section are intermeshing structures without mechanical contact. Thus, the labyrinth seal provides sealing in the housing of the singulation device between the first and second regions, maintaining durable sealing without wear.

The first sealing section formed on the singulation element and the second sealing section formed on the housing, for example on the cover assembly, provide a non-contact seal between the singulation element and the at least one inner wall of the housing, for example of the cover assembly, in which the sealing effect of the labyrinth seal is achieved by lengthening a flow path by means of the first and second sealing sections in a gap to be sealed between the singulation element and the at least one inner wall of the housing, for example of the cover assembly. In combination, in the assembled housing the first and second sealing sections provide a flow resistance substantially increased relative to the gap to be sealed. In other words, in the assembled housing the first and second sealing sections act together as a labyrinth seal such that intermeshing or meshing of the first and second sealing sections in the housing between the rotating singulation element and the cover assembly fixed thereto provides a sealing effect. For example, with meshing the first and second sealing sections may cause turbulence in a labyrinth structure formed by the intermeshing sealing sections, so that the labyrinth seal already achieves sufficient sealing without additional sealing compounds and/or sliding seals. A friction- and wear-free seal is provided in the singulation device in a simple manner. Here, the labyrinth seal may be formed by meshing of curved rib structures, the curved rib structures in the first and second sealing sections being formed such that, despite curvature, they are arranged in a contactless meshing engagement when the housing assembly and the cover assembly are assembled in the housing. With curved ribs it may be advantageous if the ribs are elastic so that, when the singulation element is inserted into the housing or when the cover assembly is mounted on the housing assembly, the first and second sealing sections may slide past one another despite mutual undercuts in order to reach the non-contact meshing arrangement. By contrast, ribs formed linearly, i.e., without curvature, provide simplified assembly, since with linear ribs there are no undercuts of ribs of the different sealing sections.

In various illustrative embodiments of the first and/or second aspects of the disclosure, the singulation element may be provided as a singulation element formed at least in part in the manner of a drum or hollow cylinder, or as a cup, or in disk form, such as a singulation drum, a singulation cup, or a singulation disk.

In illustrative examples in which the singulation device has a singulation element of the type of a singulation drum, the labyrinth seal is formed such that a first sealing section of the labyrinth seal is formed circumferentially on an outer mantle surface around the singulation drum, and a second sealing section of the labyrinth seal, which is in engagement therewith, is formed on the inner walls of the housing. For example, the through-openings in the singulation drum are formed as at least one radial row of through-openings, and on the outer mantle surface of the singulation drum the sealing sections of the labyrinth seal are formed respectively between an end face edge of the singulation drum and the at least one radial row on the outer mantle surface of the singulation drum. In this way, contactless sealing may be provided on the mantle surface between a surface region of the singulation drum with through-openings formed therein and the spatial regions at the end face edges. This is advantageous regardless of whether seed is supplied at the outer mantle surface—so that the first region or operating overpressure region is provided at the outer mantle surface, while, in the interior region of the singulation drum, which is partially bounded by the inner surface of the drum mantle, the second region or operating underpressure region is provided—or whether seed is supplied at the inner mantle surface—so that the first region or operating overpressure region is provided at the inner mantle surface, while, in the outer region of the singulation drum, which is partially bounded by the outer mantle surface of the drum mantle, the second region or operating underpressure region is provided.

In specific illustrative examples of the first and/or second aspects of the disclosure, the through-openings may extend substantially axially or radially through the singulation element, for example depending on the type of singulation element either as a singulation disk or singulation cup, or as a singulation drum. For example, the through-openings may be formed as through-holes extending substantially parallel to or radially with respect to the rotation axis of the singulation element, as in the case of a singulation disk or singulation cup. Alternatively, the through-openings may be provided as through-holes formed radially with respect to the rotation axis if the singulation element is provided as a hollow-cylindrical element such as a singulation drum.

In some advantageous embodiments, the housing, for example the housing assembly, may further comprise a cover element held by a retainer, the retainer being mounted fixed against rotation to the housing—e.g., to the cover assembly—and the cover element being configured to interrupt the pressure differential at a suitable position during rotation of the singulation element. In the housing, the cover element is arranged relative to the singulation element on a side opposite the seed side of the singulation element, in order also to cover, from the opposite side, a through-opening of the singulation element that is covered by a kernel of seed on the seed side and thus to interrupt the application of the pressure differential at the through-opening. This enables time- and position-accurate discharge of particulate material after a specified transport path through the singulation element.

In some illustrative first embodiments, the housing may be formed from a housing assembly and a cover assembly, and the cover assembly may further comprise a housing cover and a bell insert received fixed against rotation in the housing cover, the second sealing section being formed at a circumference of the bell insert. Here, the second region is defined via the bell insert independently of the housing cover. Thus, a pressure differential may be provided at the singulation element. The geometry of the second sealing section may be used to determine leakage of the seal and thereby influence the pressure differential between the first and second regions in the housing. In addition, the housing cover may provide additional sealing of the housing.

In an advantageous refinement of the illustrative first embodiments, the cover assembly may further comprise a cover element that is mounted fixed against rotation to the cover assembly and is configured to interrupt the pressure differential at a suitable position during rotation of the singulation element. Here, the cover element may mount the bell insert received in the housing cover fixed against rotation to the housing cover. This makes it possible to realize reliable mounting of the bell insert in the housing cover in a simple manner. For example, the cover element may be attached to a ring insert which may be releasably and rotationally fixedly mounted in the housing cover. Mounting the ring insert may simultaneously mount the bell insert fixed against rotation to the housing cover. Mounting the bell insert in the housing cover may also be carried out such that the bell insert is axially displaceable in the housing cover, so that manufacturing tolerances may be compensated by axial displaceability. For this purpose, an insertion or insertion depth of the bell insert in the housing cover (as a measure of a spacing between the bell insert and the housing cover) may be adjustable manually or self-adjusting due to flow and pressures, in particular by means of, e.g., a spring-mounted holder of the bell insert in the housing cover. For example, in each case an elastic/spring element may be provided between the bell insert and the housing cover and between the bell insert and the cover element (e.g., ring insert), which permits axial displacement of the bell insert against a spring action of the elastic element.

In a further advantageous refinement of the illustrative first embodiments, the housing cover may have a first flow channel or, together with an additional component that may be fastened to the housing cover, form the first flow channel, which is configured to provide an overpressure at the second sealing section at the circumference of the bell insert between the bell insert and the housing cover. The housing cover may have a second flow channel which is configured to provide a fluid connection between an environment of the singulation device and the second region or to apply an underpressure to the second region. By providing flow channels in the housing cover, impairment of the first and second regions may be avoided, since they are defined separately by the singulation element in the housing assembly and the bell insert in the cover assembly. Furthermore, the first and second flow channels may provide targeted guidance of flows in the cover assembly.

In embodiments alternative to the illustrative first embodiments, the housing cover may form the first flow channel together with the housing assembly in the housing. This may enable a compact configuration of the housing cover, since the first flow channel is not formed by the housing cover alone.

In an illustrative example herein, the first flow channel in the housing cover may have a terminal end opening at a location that lies substantially axially opposite a seed receiving region of the singulation element. The seed receiving region denotes a region of the singulation element at which seed is taken up by the singulation element, and may be understood as a region of the surface of the singulation element on a seed side of the singulation element oriented toward a seed supply, for example at a circumferential segment of the disk within an angular range of +45°, in particular ±30°. The seed receiving region may be arranged in the lower half of the singulation element, in particular—relative to the direction of rotation of the singulation element—upstream of a seed outlet from the housing. Here, an exact or approximate arrangement opposite the seed receiving region may be within a tolerance of at most 30% of a radius of the singulation element, or at most 20% of a radius of the singulation element, or at most 15% of a radius of the singulation element, or at most 10% of a radius of the singulation element, or at most 5% of a radius of the singulation element. Thus, a flow may be supplied to the labyrinth seal at the seed receiving region, so that the sealing effect of the labyrinth seal may be optimized locally at the seed receiving region in a simple and reliable manner, such that a fluid flow is directed to a region where kernel pickup is occurring and/or has just occurred. This directed fluid flow compensates for leakage of the labyrinth seal in the seed receiving region.

In some illustrative second embodiments, the housing may be formed from a housing assembly and a cover assembly, and the cover assembly may comprise a housing cover with the second sealing section formed on an inner surface of the housing cover, the second sealing section delimiting a radial inner region from a radial outer region in the housing cover, the radial inner region defining the second region in the assembled housing. This provides a structurally greatly simplified cover assembly in which the labyrinth seal is formed directly in the housing cover. Thus, an additional insert in the housing cover may be dispensed with, and the cover assembly may be manufactured cost-effectively and assembled with very few steps in a very short time.

In an advantageous refinement of the illustrative second embodiments, the housing cover may have a first flow channel which is configured to provide an overpressure at the radial outer region between the housing cover and the singulation element. The housing cover may have a second flow channel which is configured to provide a fluid connection between an environment of the singulation device and the second region or to apply an underpressure to the second region. The flow channels enable targeted guidance of desired fluid flows in the cover assembly, so that at least the second region may be pressurized at a suitable pressure. Furthermore, the sealing effect of the labyrinth seal may also be improved by providing a flow directed to the labyrinth seal.

In a further advantageous refinement of the illustrative second embodiments, the first flow channel in the housing may furthermore be configured to apply an overpressure to a seed receiving region of the singulation element relative to the second region. Here, an overpressure stream is supplied to the seed receiving region by means of the first flow channel, improving kernel pickup because a heap of kernels in the seed receiving region is flowed through by the overpressure stream and thus friction and holding forces of kernels in the seed receiving region are reduced. Accordingly, individual kernels may be released more easily from a bulk heap. Furthermore, at the seed receiving region the overpressure stream guided by the first flow channel may prevent kernels from lodging ahead of the gap, which, especially for light kernels, prevents kernels from becoming lodged in front of the gap between the housing and the singulation element.

In a further advantageous refinement of the illustrative second embodiments, the singulation element may have two radial rows of through-openings, wherein a radially inner radial row with respect to the first sealing section has openings assigned to the radial inner region and corresponds to the through-openings for taking along individual kernels of the particulate material, and wherein a radially outer radial row with respect to the first sealing section has, in the assembled housing, openings assigned to the radial outer region and in fluid communication with the first flow channel in the housing cover. This may increase the output capacity of the singulation device and/or provide flow channels through the singulation element in a simple manner.

In some illustrative embodiments, the first and second sealing sections may be formed by a plurality of ribs which are arranged in an intermeshing engagement in the housing. For example, at least two ribs may be formed in the first sealing section while at least one rib is formed in the second sealing section, the ribs in the first and second sealing sections being in contact-less meshing engagement. Alternatively, at least one rib may be formed in the first sealing section while at least two ribs are formed in the second sealing section, the ribs in the first and second sealing sections being in contactless meshing engagement. The ribs may have the same or different lengths. For example, the lengths of the ribs may decrease (monotonically or strictly monotonically) from radially inner to radially outer ribs. In some specific examples herein, a radially innermost rib may have the greatest length and following ribs outward may have the same or different (e.g., decreasing) lengths. In this way, the sealing effect of the labyrinth seal may be improved structurally. Here, different rib lengths may create different sealing regions around the circumference so that, in regions with lower sealing and therefore increased flow, dust or contamination that may have deposited in the labyrinth seal may be blown out.

In some illustrative embodiments, the labyrinth seal between the at least one inner wall of the housing, for example of the cover assembly, and the singulation element may be formed as an annular labyrinth seal extending in a circumferential direction of the singulation element. Additionally or alternatively, the singulation element may be inclined in the housing with respect to a vertical orientation. An inclination of the singulation element may lie within an angular range between 0° and 45°, for example between 0° and 30°, relative to the vertical in the housing, a tilted singulation element providing improved adhesion of particulate material in through-openings in the seed receiving region. An annular labyrinth seal provides an advantageous sealing effect at the edge of the singulation element.

In some illustrative embodiments, the pressure reservoir may provide a pressure increased relative to a pressure in the second region, and the housing, for example the housing assembly, may have a supply line connected to the first region (and, for example, to the cover assembly, if present) to apply the increased pressure to the first region and to a radially outer side of the labyrinth seal. This advantageously provides an overpressure-type singulation device.

In some illustrative embodiments, the pressure reservoir may provide a pressure reduced relative to a pressure in the first region, and the housing (for example the cover assembly, if present) may have a supply line configured to apply, to a radially outer side of the labyrinth seal, a pressure increased relative to the reduced pressure. This advantageously provides a singulation device in which the increased pressure may be higher than the pressure in the first region, so that the sealing effect of the labyrinth seal may be optimized.

In the singulation based on a pressure differential described herein, the singulation element always divides the housing into a higher-pressure region and a lower-pressure region. For kernels to adhere to the singulation element, the particulate material is located in the higher-pressure region. This region is referred to as the overpressure region; the region of lower pressure is referred to as the underpressure region. The pressure level in the overpressure region may be above the pressure level of ambient atmosphere. The pressure level in the underpressure region may be below ambient pressure or at ambient pressure. This is not limiting, as what is essential is that the pressure level in the overpressure region is above the pressure level in the underpressure region.

### BRIEF DESCRIPTION OF THE DRAWINGS

Further details of the disclosure may be found in the following detailed description of illustrative embodiments with reference to the drawings. In this regard, the drawings show in:

FIG. 1 a seeding unit of an agricultural seeder in an exploded perspective view according to some illustrative embodiments;

FIG. 2 an agricultural singulation device in a perspective view of an open housing according to illustrative embodiments;

FIG. 3 the agricultural singulation device of FIG. 2 in a cross-sectional view;

FIG. 4 the agricultural singulation device of FIG. 2 in a further cross-sectional view;

FIG. 5 a sectional view of a cover assembly according to some illustrative embodiments;

FIG. 6 the agricultural singulation device of FIG. 2 in a further cross-sectional view to illustrate some flow paths;

FIG. 7 a seeding unit of an agricultural seeder in an exploded perspective view according to alternative embodiments; and

FIG. 8 the agricultural singulation device of FIG. 7 in a schematic cross-sectional view of a section of the singulation device.

### DETAILED DESCRIPTION

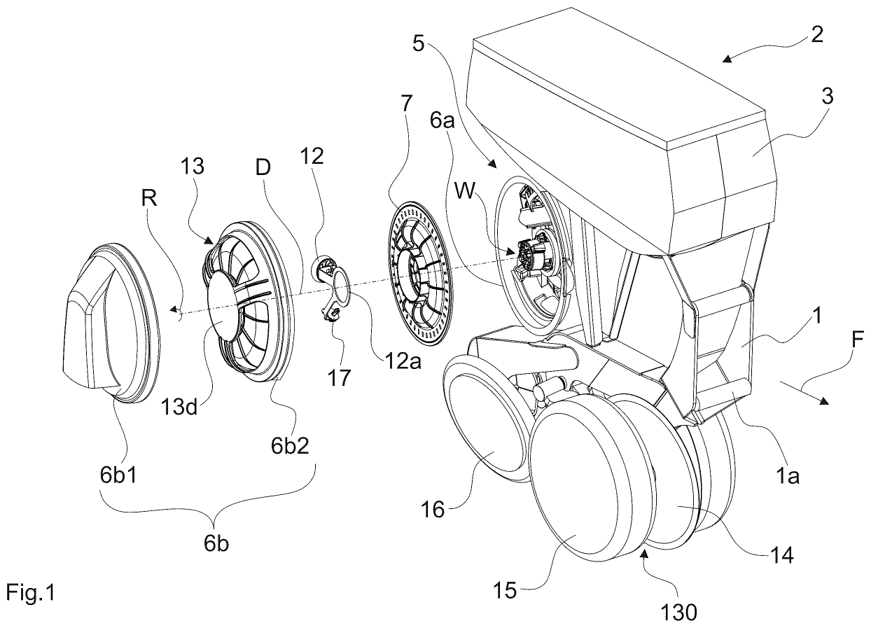

With reference to FIG. 1, a seeding unit 2 of an agricultural seeder (not shown) is illustrated in an exploded perspective view. The seeding unit 2 may be fastened, by support elements 1, to a frame oriented transversely to the direction of travel F of the agricultural seeder (not shown) (in FIG. 1, a frame element 1a of a frame oriented perpendicular to the direction of travel F, for example a telescopic frame, is shown, the frame element 1a representing a telescopic frame element). The seeding unit 2 may, in the seeder (not shown), be mounted as one of a plurality of seeding units (not shown) on the frame (not shown), so that, by means of at least one additional seeding unit (not shown) beside the seeding unit 2, one or more further seed furrows may be filled with seed and/or fertilizer may be dispensed along one or more furrows. The seeding unit 2 may be movable relative to the frame.

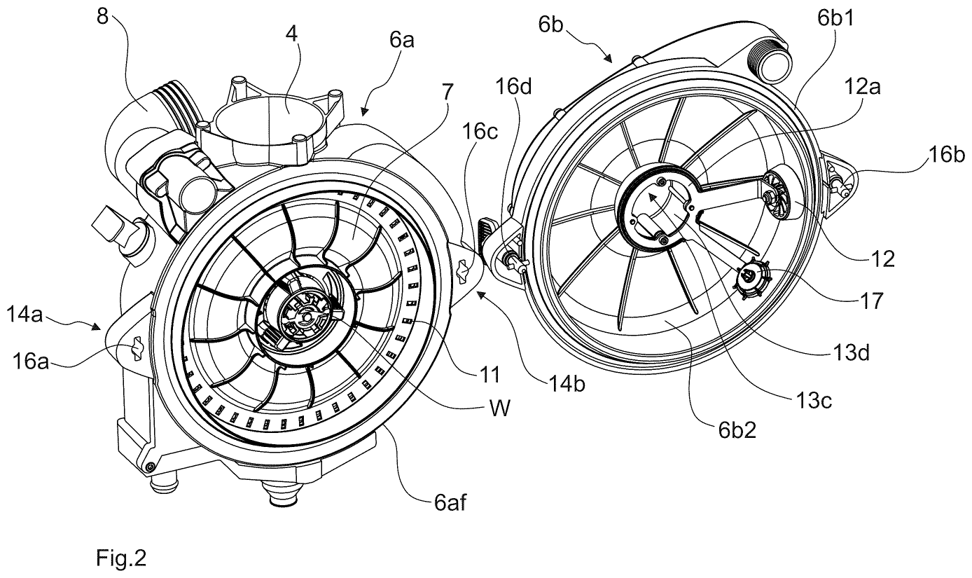

According to the depiction in FIG. 1, the seeding unit 2 comprises a hopper 3 for holding particulate material to be dispensed, in particular seed and/or fertilizer. A lower portion of the hopper 3 is configured as an outlet region in which an outlet opening is arranged (not shown in FIG. 1; see reference sign 4 in FIG. 2). Through the outlet opening (not shown in FIG. 1; see reference sign 4 in FIG. 2), the particulate material to be dispensed is supplied to a singulation device 5 which is arranged below the hopper 3.

With reference to FIGS. 1 to 3, the singulation device 5 is now described in greater detail. The singulation device 5 comprises a housing formed from a housing assembly 6a and a cover assembly 6b releasably mounted on the housing assembly 6a. Inside the housing, a singulation element 7 is arranged that may be driven in a direction of rotation R about a rotation axis D, and is preferably at least partially rotationally symmetric. The singulation element 7 is configured to at least partially singulate the particulate material that may be provided in the housing by a feed from the hopper 3. The housing has a shaft W rotatably mounted on the housing assembly 6a, by which the singulation element 7 is rotationally driven during operation of the singulation device 5. Although the singulation element 7 is illustrated in FIGS. 1 to 3 as being oriented vertically in the housing, an orientation of the singulation element 7 in the housing may also deviate from vertical without limiting the scope of the description. Reference is made here to the explanation of inclined singulation elements in the description, the disclosure regarding inclined singulation elements being incorporated herein in full by reference.

In illustrative embodiments herein, the singulation element 7 is provided at least partially in the form of a circular disk or cup, i.e., as a singulation disk/singulation cup, which is non-rotatably coupled to the shaft W so that the shaft W sets a defined rotational motion of the singulation element 7 at a predetermined rotational speed. The singulation element 7 is arranged in the housing such that a first region B1 is defined between the singulation element 7 and the housing assembly 6a, and a second region B2 is defined between the singulation element 7 and the cover assembly 6b. In the interior between the first region B1 and the second region B2, a pressure differential may be generated by a pressure reservoir (not shown).

The housing assembly 6a has an opening into which the singulation element 7 is received at least in part, the opening of the housing assembly 6a being optionally surrounded by an annular flange section (see reference sign 6af in FIG. 2).

This does not constitute a limitation, and as an alternative to the depicted embodiment, the singulation element 7 may be implemented, instead of the explicitly shown disk/cup-type singulation element, as a singulation drum formed at least partially in a drum-or cylinder-like manner (not shown).

With further reference to FIGS. 1 to 3, the singulation element 7 has, along its circumferential direction and/or in its outer region near the circumferential line, at regular intervals, suitable through-openings 11 for taking along individual kernels of the particulate material, the through-openings 11 providing spatial connections between the first region B1 and the second region B2 of the housing, with the kernels adhering at these through-openings 11 due to the pressure differential. Furthermore, the singulation device 5 may additionally comprise, at a suitable location in the housing, a cover element 12 which, by temporarily covering the through-openings 11, interrupts the pressure differential and thus prevents continued adhesion of the kernels being transported.

With reference to the illustration in FIG. 2, the through-openings 11 are arranged, in the circumferential direction of the singulation element 7, along a diameter or a radius from the rotation axis D in the region of an outer disk circumference. Alternatively, it is also conceivable that the through-openings 11 are arranged on the circumference of the singulation element 7. Although in FIGS. 1, 2, and 4 only a single radial row of through-openings 11 (i.e., the through-openings 11 only in an annular arrangement with a substantially fixed radius) is formed in the singulation element 7, this is not limiting, and instead of one radial row, two or more concentric radial rows of through-openings may be provided. For example, the through-openings of the different radial rows may all have the same size, or each radial row may have through-openings with an associated fixed size, the through-openings of at least two radial rows differing from one another.

In illustrative and non-limiting embodiments, the depicted singulation device 5 may further be implemented as an overpressure singulation, wherein, via a supply line 8 connectable to a pressure reservoir (not shown), such as a blower (not shown), a pressure may be generated in the first region B1 that is greater than a pressure in the second region B2. Alternatively, an underpressure singulation or another type of singulation is also conceivable, for example in that the first region B1 is connected to ambient atmosphere via the supply line 8, while the second region B2 is connected, via a suitable line (not shown), to an underpressure reservoir (not shown), e.g., a suction element (not shown), so that a pressure in the second region B2 is lower than a pressure in the first region B1.

Generally, in the illustrative embodiments, the housing is divided by the singulation element 7 into at least the first region B1 and the second region B2. This division of the housing by the singulation element 7 is implemented such that a pressure differential may be generated between at least the first region B1 and the second region B2.

As described above, the first region B1 and the second region B2 of the housing are spatially connected to one another via the through-openings 11, so that individual kernels of the particulate material may be carried, due to the pressure differential—particularly a resulting suction effect—between the two regions B1, B2 within the through-openings 11. Individual kernels are thereby transported, on a first side of the singulation element 7 assigned to the first region (generally the side facing the higher-pressure region), in the direction of rotation R to the cover element 12. The cover element 12 is arranged on a side of the singulation element 7 opposite the first side. The cover element 12 is furthermore configured to temporarily interrupt the pressure differential—particularly locally in the region of the cover element 12—by at least partially covering at least one through-opening 11. Owing to the interrupted pressure differential, the at least one kernel carried by the singulation element 7 is released for detachment in the region of the cover element 12. Thus, a kernel released by the cover element 12 is transferred at a defined position to a seed placement device 130, as shown in FIG. 1. In illustrative examples, the cover element 12 is formed as a roller that rolls, by friction, along the disk while the singulation element 7 rotates. According to FIG. 1, the seed placement device 130 comprises furrow-opening elements formed as disc openers 14, depth-guiding elements 15, and devices for closing a furrow 16. Additionally, the seed placement device 130 may comprise a delay device (not shown). The delay device causes a reduction in the movement speed of a kernel. The delay device may comprise a catching element that fixes the kernel at the bottom of a furrow.

Alternatively or additionally, the delay device may comprise a braking element that varies the speed of the kernel based on the forward speed of the seeding unit 2. The catching element may, for example, be formed to roll or slide. The braking element may, for example, be formed as an air outlet or as a rotating element.

With reference to FIG. 1, at least one ejector 17 that may be driven by the singulation element 7 is additionally arranged inside the housing, for example in that the ejector 17 is driven by engagement of teeth in through-openings. The ejector 17 is arranged on the second side of the singulation element 7 and, in the direction of rotation R, downstream of the cover element 12. The ejector 17 is configured to engage, at least partially, into the through-openings 11 and thus to clean the through-openings 11 of blockages and/or contamination. In doing so, firmly seated contamination, kernels, or other deposits inside the through-openings 11 are loosened by pressing out ejector elements that are formed on the ejector 17 and configured to engage in the through-openings 11. This is not limiting; instead, no pressure-interrupting element may be provided and only the ejector may be provided.

With reference to FIGS. 1, 2, 3, 4, and 6, the cover assembly 6b comprises a housing cover 6b1 and a bell insert 6b2 that is received non-rotatably in the housing cover 6b1. The bell insert 6b2 is a half-shell element that has only a central opening 13c. Furthermore, the bell insert 6b2 is in no direct mechanical contact with the singulation element 7, so that rotation of the singulation element 7 is not impaired by mechanical contact between the singulation element 7 and the bell insert 6b2. In particular, the singulation element 7 rotates freely within the housing. By means of the central opening 13c, the bell insert 6b2 may be fitted onto a central cylindrical projection 13d on an inner surface of the housing cover 6b1 and plugged onto it. This permits a non-rotatable and precise fixation of the bell insert 6b2 at a predetermined position without risk of misaligned assembly of the bell insert 6b2 on the housing cover 6b1. The central opening 13c and the projection 13d furthermore provide a connection between the second region B2 and a flow channel 28 in the housing cover 6b1, which is in communication with an environment of the singulation device 5. As a result, the second region B2 may be maintained at ambient pressure. Alternatively, coupling to an underpressure reservoir (not shown) may be effected via the flow channel 28.

In some illustrative embodiments, mounting of the bell insert 6b2 in the housing cover 6b1 may be performed such that the bell insert 6b2 is inserted axially displaceably into the housing cover 6b1 and mounted at a desired insertion/setting depth in the housing cover 6b1. By mounting at the desired insertion/setting depth in the housing cover 6b1, manufacturing tolerances may be compensated by the set axial displacement. For example, the insertion/setting depth of the bell insert 6b2 in the housing cover 6b1 may be set manually by inserting or screwing the bell insert 6b2 onto the projection 13d, the projection 13d having an external thread with a specified thread pitch (not shown) or being configured to displace the bell insert 6b2 in the axial direction along the projection 13d. In other illustrative examples, the insertion/setting depth of the bell insert 6b2 in the housing cover 6b1 may additionally be set as a result of flows and pressures in the housing acting on the bell insert 6b2. In further illustrative examples, a spring-mounted holder of the bell insert 6b2 in the housing cover 6b1 may be provided, the insertion/setting depth of the bell insert 6b2 in the housing cover 6b1 being set by spring elements (not shown). This spring-mounted holder may be self-adjusting in that, due to flows and pressures in the housing acting on the bell insert 6b2, an axial displacement of the bell insert 6b2 in the housing cover 6b1 is set. For example, a resilient element (not shown) may be provided in each case between the bell insert 6b2 and the housing cover 6b1 and between the bell insert 6b2 and the ring insert 12a, which permits axial displacement of the bell insert 6b2 against a spring action of the resilient element (not shown).

With reference to FIG. 2, fixation of the bell insert 6b2 to the housing cover 6b1 may be effected by the cover element 12 and/or the ejector 17, which is mounted on the projection 13d. The cover element 12 and/or the ejector 17 may be attached to a ring insert 12a that is mounted on the projection 13d and thus prevents the bell insert 6b2 from slipping off the projection 13d. For example, the ring insert 12a may be releasably or permanently mounted to the projection 13d by screws or bolts.

With reference to FIG. 2, attachment of the cover assembly 6b to the housing assembly 6a is described. The housing assembly 6a has projections/lugs 14a, 14b with through-holes 16a and 16c formed therein. The cover assembly 6b has pin-latch elements 16b and 16d which are configured to be inserted into the through-holes 16a and 16c for a locking connection. For example, the pin-latch elements 16b and 16d are formed on the housing cover 6b1 in order to releasably mount the housing cover 6b1 with the bell insert 6b2 inserted therein on the housing assembly 6a. Alternatively, the pin-latch elements 16b and 16d may be formed on the bell insert 6b2. In further alternative embodiments, through-holes (not shown) may be formed on the housing cover 6b1 or the bell insert 6b2 to engage with pin-latch elements (not shown) on the housing assembly 6a. When the housing cover 6b1 is mounted on the housing assembly 6a, sealing of the housing is effected, for example in that the housing cover 6b1, with a sealing surface upon mounting on the housing assembly 6a, bears sealingly against a seal of the housing assembly 6a.

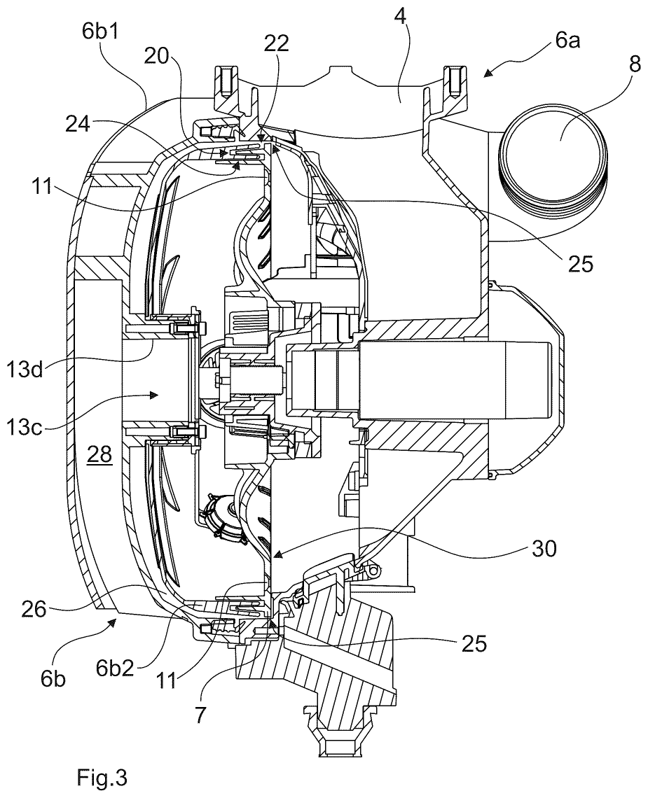

With reference to FIGS. 3, 4, and 6, the singulation device 5 further has a labyrinth seal 20 which is formed by a first sealing section 22 at a circumference of the singulation element 7 and a second sealing section 24 on the cover assembly 6b, for example at a circumference of the bell insert 6b2, such that the first sealing section 22 and the second sealing section 24 are intermeshing structures without mechanical contact. Thus, the labyrinth seal 20 provides sealing in the housing of the singulation device 5 between the first region B1 and the second region B2, maintaining durable sealing without wear.

The first sealing section 22 formed on the singulation element 7 and the second sealing section 24 formed on the cover assembly 6b provide a non-contact seal between the singulation element 7 and the cover assembly 6b, wherein a sealing effect of the labyrinth seal 20 is achieved by lengthening a flow path by means of the first and second sealing sections 22, 24 in a gap to be sealed between circumferential (azimuthal) edges of both the singulation element 7 and the cover assembly 6b. In combination, the first and second sealing sections 22, 24 provide, in the assembled housing, a flow resistance substantially increased relative to the gap to be sealed. In other words, in the assembled housing, the first and second sealing sections 22, 24 act together as the labyrinth seal 20 such that intermeshing (meshing) of the first and second sealing sections 22, 24 in the housing, between the rotating singulation element 7 and the cover assembly 6b fixed thereto, provides a sealing effect. For example, in meshing, the first and second sealing sections 22, 24 may cause turbulence in a labyrinth structure formed by the intermeshing sealing sections, so that the labyrinth seal 20 already achieves sufficient sealing without additional sealing compounds and/or sliding seals. A friction-and wear-free seal is thus provided in the singulation device 5 in a simple manner.

In illustrative embodiments, the labyrinth seal 20 may be formed by a plurality of ribs 22s, 24s, the plurality of ribs 22s, 24s of the first and second sealing sections 22, 24 being in meshing engagement with one another without contact. For example, the first sealing section 22 may have one rib that is in meshing engagement with two ribs of the second sealing section 24, or vice versa. With regard to the labyrinth seal 20 shown in FIGS. 3, 4, and 6, the first sealing section 22 may have two ribs 22s and the second sealing section 24 may have two ribs 24s. The ribs 22s and the ribs 24s may be in meshing engagement without contact with one another, as shown in FIGS. 3, 4, and 6. A radially inner rib of the first sealing section 22 may be longer than a radially outer rib of the same section, in order to lengthen a flow path in the second region B2 toward the labyrinth seal 20 and further suppress leakage flows.

With reference to FIGS. 3, 5, and 6, further advantageous configurations are described which, in addition to the labyrinth seal 20, provide application of an overpressure to the labyrinth seal 20 from the side of the cover assembly 6b. In this way, a sealing effect of the labyrinth seal 20 may be improved by suppressing leakage through the labyrinth seal 20. For this purpose, as shown in FIG. 3, the cover assembly 6b has a flow channel 26 which is configured to apply, via the flow channel 26, an overpressure on the cover side to the labyrinth seal 20. For example, the housing cover 6b1, according to FIGS. 3, 5, and 6, has the flow channel 26 which is configured to provide an overpressure at the second sealing section 24 at the circumference of the bell insert 6b2 between the bell insert 6b2 and the housing cover 6b1. The housing cover 6b1 may furthermore have the flow channel configured to provide a fluid connection between an environment of the singulation device and the second region B2, or to apply a vacuum to the second region B2, as described above.

In some illustrative embodiments, the labyrinth seal 20 between the cover assembly 6b and the singulation element 7 may be formed as an annular labyrinth seal formed in the circumferential direction of the singulation element 7.

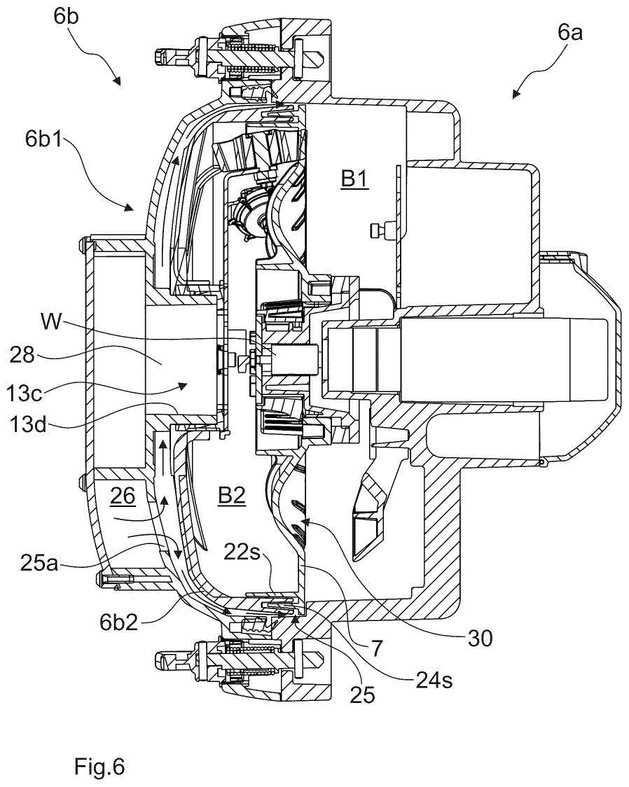

According to FIGS. 3 and 6, the first flow channel 24 in the housing cover 6b1 has a terminal opening 25a which is in fluid communication with the flow channel 26 and opens into a channel section of the flow channel 26 that is defined between the bell insert 6b2 and the housing cover 6b1. This channel section of the flow channel 26 directs, at one end, the fluid flow toward a region that lies substantially axially opposite a seed receiving region 30 of the singulation element 7. By means of the flow channel 24, an overpressure stream is guided to the seed receiving region 30, thereby improving kernel pickup, since a heap of kernels in the seed receiving region 30 is flowed through by the overpressure stream. As a result, friction and holding forces of kernels in the seed receiving region 30 are reduced so that individual kernels may be released more easily from a bulk heap. Furthermore, at the seed receiving region 30, the over-pressure stream may prevent kernels from lodging ahead of the gap, which-especially for light kernels-prevents kernels from becoming lodged in front of the gap between the housing and the singulation element 7. FIG. 6 illustrates, for this purpose, a flow path of a fluid stream in the flow channel 26 by arrows that enter, through the terminal opening 25a, into the channel section of the flow channel 26 between the bell insert 6b2 and the housing cover 6b1 and are directed toward the region that lies substantially axially opposite the seed receiving region 30 of the singulation element 7. Furthermore, in the channel section, the fluid flow distributes in each case toward the labyrinth seal 20, as indicated by arrows directed vertically upward in the representation of FIG. 6. In this way, an annular configuration of the labyrinth seal 20 in the region between the housing cover 6b1 and the bell insert 6b2 may be supplied, distributed toward the labyrinth seal 20, wherein the cylindrical projection 13d, on which the bell insert 6b2 is mounted non-rotatably, blocks a connection to the opening 13c. Thus, between the flow channel 26 and the second region B2 there is no connection from the side of the cover assembly 6b.

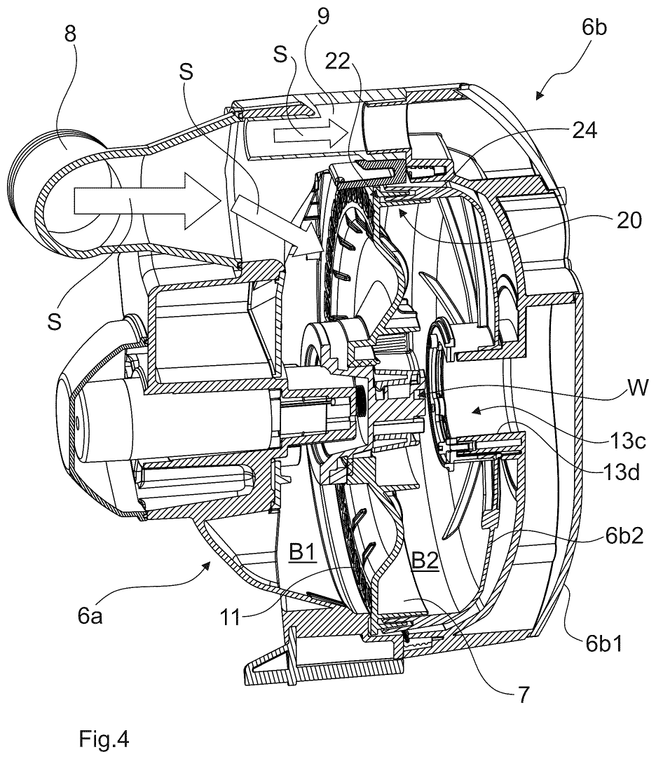

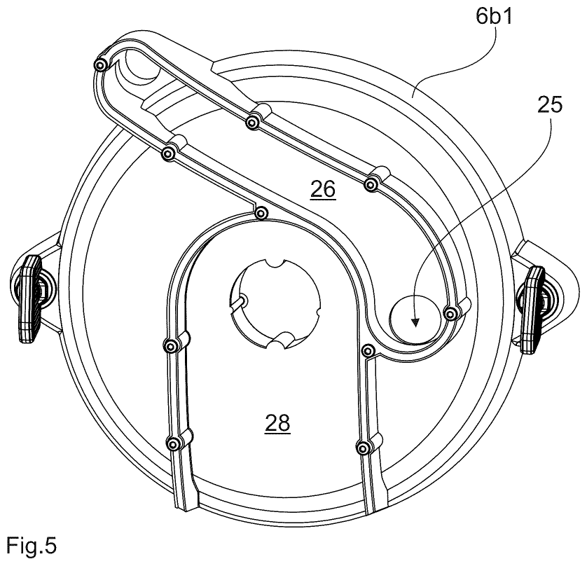

With reference to FIG. 5, an illustrative and non-limiting configuration of the flow channel 26 in the housing cover 6b1 is shown that guides an overpressure flow to the opening 25. For example, the flow channel 26 may be configured to connect the opening 25 to a supply line 9 in the cover assembly 6b, which is connected to the supply line 8 in the housing assembly 6a. As shown in FIG. 4, the supply line 8 may have a branch in the housing assembly 6a, so that an overpressure flow S provided via the supply line 8 is divided into an overpressure partial flow S1 for applying overpressure to region B1 and a branched overpressure partial flow S2 that is applied via the supply line 9 and the flow channel 26 to the labyrinth seal 20. The over-pressure partial flow S1 may be greater than the overpressure partial flow S2. This is not limiting, and the overpressure partial flow S2 may also be provided to the singulation via an additional line (not shown).

With further reference to FIGS. 3 and 5, the flow channel 28 is also shown, which connects the opening 13c in the cover assembly 6b to the environment of the singulation device 5 or to an underpressure reservoir (not shown).

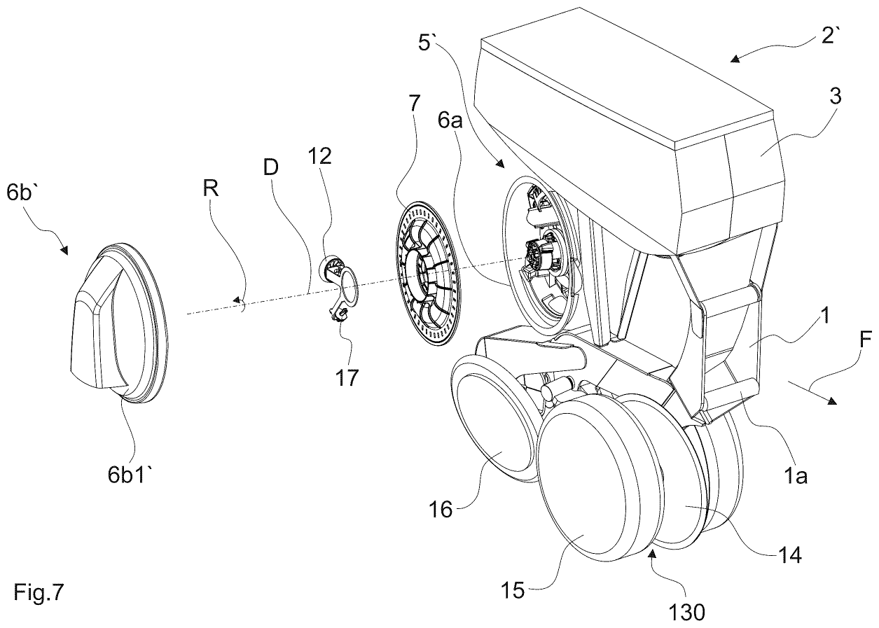

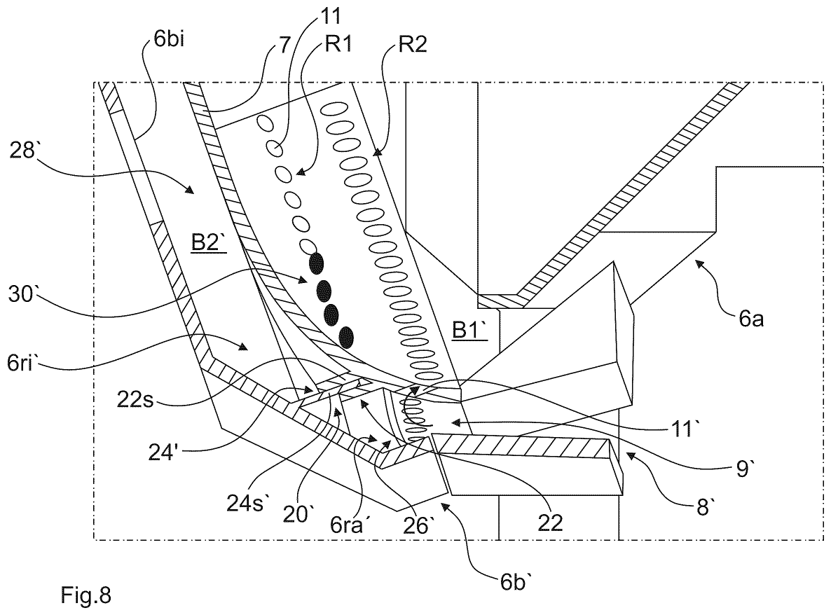

With reference to FIGS. 7 and 8, a seeding unit 2′ of an agricultural seeder (not shown) according to alternative embodiments is illustrated in an exploded perspective view. The seeding unit 2′ differs from the seeding unit 2 described above with reference to FIG. 1 by a singulation device 5′, which is provided instead of the singulation device 5 in FIG. 1. Identical reference signs between FIGS. 1 and 7 denote identical elements that correspond to one another in FIGS. 1 and 7; reference is made to the description of these identical elements with regard to FIG. 1 above, which is incorporated in its entirety here by reference into the description of FIGS. 7 and 8.

With further reference to FIGS. 7 and 8, the seeding unit 2′ may be fastened, by support elements 1, to a frame oriented transversely to the direction of travel F of the seeder (not shown) (in FIG. 7, a frame element 1a of a frame oriented perpendicular to the direction of travel F, for example a telescopic frame, is shown, the frame element 1a representing a telescopic frame element) of the agricultural seeder (not shown). The seeding unit 2′ may, in the seeder (not shown), be mounted as one of a plurality of seeding units (not shown) on the frame (not shown), so that, by means of at least one additional seeding unit (not shown) beside the seeding unit 2′, one or more further seed furrows may be filled with seed and/or fertilizer may be dispensed along one or more furrows. In some illustrative examples, the seeding unit 2′ may be movable relative to the frame to compensate terrain contour. For example, the at least one seeding unit 2′ may be provided on a parallelogram linkage (not shown) or another linkage arrangement (not shown) so as to be height-adjustable and/or laterally displaceable on a seeder (not shown).

According to FIG. 7, the seeding unit 2′ comprises a hopper 3 for holding particulate material to be dispensed, in particular seed and/or fertilizer. A lower portion of the hopper 3 is configured as an outlet region in which an outlet opening is arranged (not shown in FIG. 1; see the corresponding description of reference sign 4 in FIG. 2, which is incorporated herein in full at this point). Through the outlet opening (not shown in FIG. 1; see reference sign 4 in FIG. 2), the particulate material to be dispensed is supplied to a singulation device 5′ which is arranged below the hopper 3.

The agricultural singulation device 5′ is provided for singulating particulate material, in particular seed and/or fertilizer. In illustrative embodiments, as now described with reference to FIGS. 7 and 8, the singulation device 5′ comprises a housing including a housing assembly 6a with a shaft W rotatably mounted therein, which defines a rotation axis D, and a cover assembly 6b′ releasably mounted on the housing assembly 6a. The singulation device 5′ furthermore comprises a singulation element 7 that is received in an interior defined in the housing. The singulation element 7 is coupled to the shaft W such that the singulation element 7 is mounted rotatably relative to the housing. The singulation element 7 is arranged in the housing such that a first region B1′ (see the corresponding description of reference sign B1, which is incorporated here in its entirety) is defined between the singulation element 7 and the housing assembly 6a, and a second region B2′ (see the corresponding description of reference sign B2, which is incorporated here in its entirety) is defined between the singulation element 7 and the cover assembly 6b′, a pressure differential being generatable between these regions to cause adhesion of particulate material to the singulation element 7. The singulation device 5′ further has a labyrinth seal 20′ which is formed by a first sealing section 22 at a circumference of the singulation element 7 and a second sealing section 24′ at the cover assembly 6b′, such that the first sealing section 22 and the second sealing section 24′ are intermeshing structures without mechanical contact.

With further reference to FIG. 8, the cover assembly 6b′ comprises a housing cover 6b1′ with a first flow channel 26′ that is configured to provide an overpressure at the radial outer region 6ra′ between the housing cover 6b1′ and the singulation element 7. The housing cover 6b1′ further has a second flow channel 28′ that is configured to provide a fluid connection between an environment of the singulation device 5′ and the second region B2′, or to apply an under-pressure to the second region B2′. The flow channel 28′ may be configured analogously to the flow channel 28; reference is hereby made to that description, which is incorporated herein in full. In some illustrative examples, an opening 6bi may be formed in the housing cover 6b1′ through which a connection to the environment or to an underpressure reservoir may be made. In some examples, the opening 6bi may be formed coaxially with the rotation axis D. Furthermore, the cover assembly 6b′ may additionally comprise a cover element 12 and an ejector 17, wherein the cover element, as already described above with reference to FIG. 1, serves to interrupt the pressure differential and thus the continued adhesion of transported kernels; reference is made to the corresponding description of elements 12 and 17 above.

In illustrative embodiments herein, the first flow channel 26′ in the housing cover 6b1′ may additionally be configured to apply, to a seed receiving region 30′ of the singulation element 7, an overpressure relative to the second region B2′. The seed receiving region 30′ denotes a region of the disk at which kernels are taken up by the singulation element 7.

With reference to FIG. 8, the singulation element 7 has two radial rows R1, R2 of through-openings, wherein a radial inner radial row R1 (a first row) with respect to the first sealing section 22 has openings assigned to the radial inner region 6ri′ and corresponds to the through-openings 11 for taking along individual kernels of the particulate material. A radial outer radial row R2 (a second row) with respect to the first sealing section 22 has, in the assembled housing, openings 11′ assigned to the radial outer region 6ra′ and in fluid communication with the first flow channel 26′ in the housing cover 6b1′. The size and/or number of the openings 11 and 11′ may be the same or different, wherein a size and/or number of the openings 11′ of the second row may be greater than a size and/or number of the openings 11 of the first row.

In some specific illustrative examples, the size of the openings 11 may be greater than the size of the openings 11′. For example, the size of the openings 11′ of the second row may be ±50% of the size of the openings of the first row. Additionally or alternatively, the number of openings of the respective rows may be different.

With further reference to FIG. 8, the labyrinth seal 20′ is shown according to some illustrative embodiments. The first and second sealing sections 22, 24′ may in this case, similar to the sealing sections 22, 24, be formed by a plurality of ribs 22s and 24s′ that are arranged in the housing in an intermeshing engagement. For example, the ribs of the plurality of ribs 22s, 24s′ of the first and second sealing sections 22, 24′ may be in meshing engagement with one another without contact. For example, the first sealing section 22 may have one rib that is in meshing engagement with two ribs of the second sealing section 24′, or vice versa. With regard to the labyrinth seal 20′ shown in FIG. 8, the first sealing section 22 may have two ribs 22s and the second sealing section 24′ may have one rib 24s′. The ribs 22s and the rib 24s′ may be in meshing engagement without contact with one another, as shown in FIG. 8. The ribs of the first sealing section 22 may have the same or different lengths. As an alternative to the labyrinth seal 20′ shown, the first sealing section 22 may have more than two ribs 22s and the second sealing section 24′ may have more than one rib 24s′, the ribs of the first and second sealing sections 22, 24′ intermeshing without contact.

In some illustrative embodiments, and with reference to FIG. 8, the singulation element 7 may be inclined by an angle with respect to a vertical orientation in the housing, for example an angle between 0° and 45°, for example between 0° and 25°, preferably between 0° and 20°, more preferably between 0° and 15°. The inclination of the singulation element 7 may be set such that an upper edge of the singulation element 7 in the housing, in a vertical plan view of the singulation element 7 in the housing, covers only a portion of the singulation element 7. Such an inclined singulation element allows advantageous adhesion of kernels in the through-openings 11 of the singulation element 7, since the adhesion is supported by the weight of the kernels in the seed receiving region 30.

In some illustrative embodiments, the labyrinth seal 20′ between the cover assembly 6b′ and the singulation element 7 may be formed as an annular labyrinth seal formed in the circumferential direction of the singulation element 7.

In some illustrative embodiments, and with further reference to FIG. 8, a pressure reservoir (not shown) may provide a pressure increased relative to a pressure in the second region B2′, and the housing assembly 6a may have a supply line 8′ that is connected to the first region B1′ and the cover assembly 6b′ to apply the increased pressure to the first region B1′.

In other illustrative embodiments, and with further reference to FIG. 8, the pressure reservoir (not shown) may provide a pressure reduced relative to a pressure in the first region B1′, and the cover assembly 6b′ may have a supply line 9′ that is configured to apply, to a radially outer side of the labyrinth seal 20′, a pressure increased relative to the reduced pressure. The in-creased pressure may be higher than the pressure in the first region B1′. In this case, the pressure reservoir (not shown) may be provided as an additional separate pressure reservoir (not shown) in order to apply at least part of a pressure to the labyrinth seal 20′.

In other illustrative embodiments, and as shown in FIG. 8, the supply line 8′ may be connected directly to the supply line 9′ so that a fluid flow supplied to the supply line 8′ is fed directly and completely into the supply line 9′, in particular without losses. In this case, the region B1′ is not supplied directly by the supply line 8′—in particular, there is no direct supply of the region B1′ by the housing assembly 6a—however, the region B1′ is supplied indirectly by the supply lines 8′ and 9′, which feed a fluid flow for the labyrinth seal 20′ via the flow channel 26′. Here, the flow channel 26′ is in fluid communication with region B1 via the openings 11′ of the radial row R2. A radially outer side of the labyrinth seal 20′ is subjected to the increased pressure to provide a sealing effect of the labyrinth seal 20′.

Although FIG. 8 shows that the supply line 8′ is connected only directly to the supply line 9′, this is not limiting; instead, the supply line 8′ in the housing assembly 6a may be configured for a direct supply of the region B1′, and a branch (not shown) from the supply line 8′ in the housing assembly 6a may be connected to the supply line 9′ in the cover assembly 6b′. In this case, the radial row R2 with the openings 11′ is not provided, and the supply line 9′ is connected only to the flow channel 26′ so that a fluid flow branched from the supply line 8′ and fed through the supply line 9′ to the flow channel 26′ is directed only toward the labyrinth seal from the side of the cover assembly 6b′.

In some illustrative embodiments of the singulation device 5, 5′ described above, a feed of a fluid to the labyrinth seal from the side of the cover assembly 6b, 6b′ may be provided to apply pressure to the labyrinth seal from the side of the cover assembly 6b, 6b′. A specific gap size in the meshing between the first and second sealing sections 22, 24, 24′ may be provided (for example, by a suitable selection of geometric dimensions for the ribs of the first and second sealing sections 22, 24, 24′ and/or by the positioning of the ribs of the first and second sealing sections 22, 24, 24′) so that a specific leakage flow through the labyrinth seal into the first region B1, B1′ is tolerated. For this purpose, for example, a pressure higher than a pressure applied to the first region B1, B1′ may be applied to the labyrinth seal from the side of the cover assembly 6b, 6b′, e.g., via a suitable pressure source and/or a nozzle formed in the cover assembly 6b, 6b′ to direct a specific flow toward the labyrinth seal. By means of a leakage flow flowing from the side of the cover assembly 6b, 6b′ through the labyrinth seal into the first region B1, B1′, a loosening of particulate material in the seed receiving region 30, 30′ may be achieved, so that friction and holding forces between kernels in the particulate material in the seed receiving region 30, 30′ are reduced.

Although in some illustrative embodiments a coupling of flow channels and/or supply lines in the cover assembly with a pressure reservoir is described that is provided to apply pressure to the first region, this is not limiting, and an additional separate pressure reservoir, e.g., a blower, a pressurized gas in a container, etc., may be provided instead exclusively to support application of pressure to the labyrinth seal from the side of the cover assembly. The pressure for applying pressure to the labyrinth seal may be provided at least in part by the additional separate pressure reservoir. For example, in some specific and non-limiting embodiments herein, the additional separate pressure reservoir may be integrated into, integrable into, or coupleable to the cover assembly.

Although embodiments are described above with reference to FIGS. 1 to 8 in which a singulation element is mounted rotatably in a housing assembly, this does not limit the described embodiments; instead, the singulation element may be mounted rotatably on a housing cover.

Although in the depictions of FIGS. 1 to 8 the singulation elements are each shown as a singulation disk and/or a singulation cup, this does not limit the present description of the figures, and each embodiment described with respect to FIGS. 1 to 8 may instead also be realized with a singulation drum as the singulation element.

Where approximate language such as “about,” “approximately,” or “substantially,” or similar, is used in this description, this denotes an approximation within a customary measurement or manufacturing tolerance, for example, without limitation, a deviation of at most ±20%, or at most ±15%, or at most ±10%, or at most ±5%.

It is understood that the features mentioned in the exemplary embodiments described above are not limited to these specific combinations and are also possible in any other combinations.

It is further understood that the geometries shown in the figures are merely exemplary and may also be implemented in any other configurations.

1. An agricultural singulation device for singulating particulate material, in particular seed and/or fertilizer, comprising:
a housing with a shaft rotatably mounted in an interior of the housing and defining a rotation axis, and
a singulation element received in the interior of the housing, the singulation element being coupled to the shaft such that the singulation element is mounted rotatably relative to the housing,
wherein the singulation element is arranged in the housing such that a first region and a second region are defined in the interior and are separated from one another by the singulation element, so that a pressure differential may be generated in the interior between the first region and the second region by means of a pressure reservoir,
wherein the singulation element has a radial row of through-openings suitable for taking along individual particles of the particulate material, the through-openings providing spatial connections between the first region and the second region of the housing and the particles adhering at these through-openings in the first region due to the pressure differential, and
wherein the singulation device further comprises a labyrinth seal provided in the second region, which is formed by a first sealing section formed at a circumference of the singulation element and a second sealing section at one or more inner walls of the housing, such that the first sealing section and the second sealing section are intermeshing structures without mechanical contact.

2. The singulation device of claim 1, wherein the housing further comprises, in the second region, a cover element held by a retainer fixed to the housing, the cover element being configured to interrupt the pressure differential at a suitable position during rotation of the singulation element.

3. The singulation device of claim 2, wherein the housing is formed from a housing assembly, which together with the singulation element defines the first region, and a cover assembly, which together with the singulation element defines the second region, and wherein the cover assembly further comprises a housing cover and a bell insert fixed against rotation in the housing cover, the second sealing section being formed at a circumference of the bell insert.

4. The singulation device of claim 3, wherein the cover element fixes the bell insert in the housing cover in a rotationally fixed manner.

5. The singulation device of claim 4, wherein the housing cover has a first flow channel configured to provide overpressure at the second sealing section at the circumference of the bell insert between the bell insert and the housing cover, and wherein the housing cover has a second flow channel configured to provide a fluid connection between an environment of the singulation device and the second region or to apply an underpressure to the second region.

6. The singulation device of claim 5, wherein the first flow channel in the housing cover has a terminal end opening at a location that lies substantially axially opposite a seed receiving region of the singulation element.

7. The singulation device of claim 1, wherein the housing is formed from a housing assembly, which together with the singulation element defines the first region, and a cover assembly, which together with the singulation element defines the second region, and wherein the cover assembly comprises a housing cover with the second sealing section formed on an inner surface of the housing cover, which delimits a radial inner region from a radial outer region in the housing cover the radial inner region defining the second region in the assembled housing.

8. The singulation device of claim 7, wherein the housing cover has a first flow channel configured to provide overpressure at the radial outer region between the housing cover and the singulation element, and wherein the housing cover has a second flow channel configured to provide a fluid connection between an environment of the singulation device and the second region or to apply an underpressure to the second region.

9. The singulation device of claim 8, wherein the first flow channel in the housing cover is further configured to apply an overpressure to a seed receiving region of the singulation element relative to the second region.

10. The singulation device of claim 7, wherein the singulation element has two radial rows of through-openings, wherein a radially inner row with respect to the first sealing section has openings assigned to the radial inner region and corresponds to the through-openings for taking along individual particles of the particulate material, and wherein a radially outer row with respect to the first sealing section has, in the assembled housing, openings assigned to the radial outer region and in fluid communication with the first flow channel in the housing cover.

11. The singulation device of claim 1, wherein the first and second sealing sections are formed by a plurality of ribs arranged in an intermeshing engagement in the housing.

12. The singulation device of claim 1, wherein the labyrinth seal between the housing and the singulation element is formed as an annular labyrinth seal extending in a circumferential direction of the singulation element, and/or wherein the singulation element is inclined in the housing relative to a vertical orientation.

13. The singulation device of claim 1, wherein the pressure reservoir provides a pressure increased relative to a pressure in the second region, and the housing has a supply line connected to the first region to apply the increased pressure to the first region and to a radially outer side of the labyrinth seal.

14. The singulation device of claim 1, wherein the pressure reservoir provides a pressure reduced relative to a pressure in the first region, and the housing has a supply line configured to apply, to a radially outer side of the labyrinth seal, a pressure increased relative to the reduced pressure.

15. The singulation device of claim 14, wherein the increased pressure is higher than the pressure in the first region.
